(19) United States
(12) Patent Application Publication
(10) Pub. No.: US 2025/0287396 A1
(43) Pub. Date: Sep. 11, 2025

(54) Method And Apparatus For Scheduling Of Multi-Cell Uplink And Downlink Transmissions With Single Downlink Control Information

(71) Applicant: MediaTek Inc., Hsinchu City (TW)

(72) Inventors: Chi-Hsuan Hsieh, Hsinchu City (TW); Wei-De Wu, Hsinchu City (TW); Yi-Ju Liao, Hsinchu City (TW); Pei-Kai Liao, Hsinchu City (TW)

(21) Appl. No.: 18/859,532

(22) PCT Filed: Apr. 18, 2023
(86) PCT No.: PCT/CN2023/088967

§ 371 Date: Oct. 23, 2024

Related U.S. Application Data
(60) Provisional application No. 63/336,401, filed on Apr. 29, 2022.

(30) Foreign Application Priority Data
Apr. 18, 2023 (WO) PCT/CN2023/08896

(51) Int. Cl. H04W 72/232; H04L 5/00; H04W 72/1263

(52) U.S. Cl. CPC H04W 72/232; H04L 5/0044; H04W 72/1263

(57) ABSTRACT

Various solutions for improvement of a scheduling of multi-cell PUSCH/PDSCH transmission with a single DCI are described. An apparatus may receive a DCI indicating a scheduling of a plurality of cells from a network node of a wireless network. The DCI includes a first DCI, a second DCI, or a third DCI. The apparatus may perform a PDSCH reception or a PUSCH transmission with at least one of the plurality of cells based on the DCI. The first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

### CROSS REFERENCE TO RELATED PATENT APPLICATION(S)

The present disclosure is part of U.S. National Stage filing of International Patent Application No. PCT/CN2023/088967, filed 18 Apr. 2023, which claims the priority benefit of U.S. Provisional Patent Application No. 63/336,401, filed on 29 Apr. 2022. The contents of aforementioned application are herein incorporated by reference in its entirety.

### TECHNICAL FIELD

The present disclosure is generally related to mobile communications and, more particularly, to improve a scheduling of multi-cell physical uplink shared channel/physical downlink shared channel (PUSCH/PDSCH) transmission with a single downlink control information (DCI).

### BACKGROUND

Unless otherwise indicated herein, approaches described in this section are not prior art to the claims listed below and are not admitted as prior art by inclusion in this section.

For current network implementations, one base station (BS) is operable to provide radio coverage to a specific geographical area using a plurality of cells forming a radio access network. The BS may support the operations of the plurality of cells, and each cell may be operable to provide services to at least one user equipment (UE) within its radio coverage. Specifically, each cell may provide services to serve one or more UEs within its radio coverage based on at least one downlink control information (DCI), where a radio coverage of one cell may overlap with another radio coverage of other cell(s). In one example, each cell may schedule a downlink/uplink (DL/UL) resource to one UE within its radio coverage by one DCI for performing a DL/UL transmission. If the UE can support more than one cells (e.g., in dual connectivity/carrier aggregation), the UE may receive more than one DCI for scheduling DL/UL transmissions with the more than one cells. As that, the network and the BS have to configure a plurality of DCIs corresponding to the plurality of cells respectively to the UE so as to schedule resources for the DL/UL transmissions between the UE and the cells, which may lack of transmission efficiency and waste available network resources. In addition, there is a bit number limit for decoding the DCI if one specific decoding technique (e.g., polar decoding technique) is utilized by the UE. Accordingly, a field number/size of the DCI should comply with a bit-limit rule/regulation.

Accordingly, how to improve a scheduling of multi-cell PUSCH/PDSCH transmission with a single DCI becomes an important issue for the newly developed wireless communication network. Therefore, there is a need to provide a proper DCI structure/segment design to improve scheduling efficiency and comply with some specific decoding rules.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to improvement of a scheduling of multi-cell UL (e.g., PUSCH)/DL (e.g., PDSCH) transmission with a single DCI.

In one aspect, a method may involve a processor of an apparatus receiving a DCI indicating a scheduling of a plurality of cells from a network node of a wireless network. The DCI includes a first DCI, a second DCI, or a third DCI, the first DCI corresponds to a one-segment DCI structure, and the second DCI and the third DCI correspond to a two-segment DCI structure. The method may also involve the processor of the apparatus performing a PDSCH reception or a PUSCH transmission with at least one of the plurality of cells based on the DCI. The first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

In one aspect, a method may involve a processor of a network node configuring a DCI indicating a scheduling of a plurality of cells to an apparatus of a wireless network. The DCI includes a first DCI, a second DCI, or a third DCI. The first DCI corresponds to a one-segment DCI structure, and the second DCI and the third DCI correspond to a two-segment DCI structure. The method may also involve the processor of the network node transmitting the DCI to the apparatus to schedule a PDSCH reception or a PUSCH transmission with at least one of the plurality of cells based on the DCI. The first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a DCI reception corresponding to a plurality of cells in accordance with the present disclosure.

FIG. 2 is a diagram depicting an example scenario illustrating two types of DCI structure in accordance with the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improvement of a scheduling of multi-cell PUSCH/PDSCH transmission with a single DCI. According to the present disclosure, a number of possible solutions may be implemented separately or jointly. That is, although these possible solutions may be described below separately, two or more of these possible solutions may be implemented in one combination or another.

In 3rd Generation Partnership Project (3GPP), a radio access network (e.g., 5G NR access network) may include a plurality of BSs (e.g., Next Generation Node-Bs (gNBs)) to communicate with a plurality of mobile stations referred as UEs. For current network implementations, one BS is operable to provide radio coverage to a specific geographical area using a plurality of cells forming a radio access network. The BS may support the operations of the plurality of cells, and each cell may be operable to provide services to at least one UE within its radio coverage. Specifically, each cell may provide services to serve one or more UEs within its radio coverage based on at least one DCI, where a radio coverage of one cell may overlap with another radio coverage of other cell(s). In one example, each cell may schedule a DL/UL resource to one UE within its radio coverage by one DCI for performing a DL/UL transmission. If the UE can support more than one cell (e.g., application in dual connectivity), the UE may receive more than one DCI for scheduling DL/UL transmissions with the more than one cells.

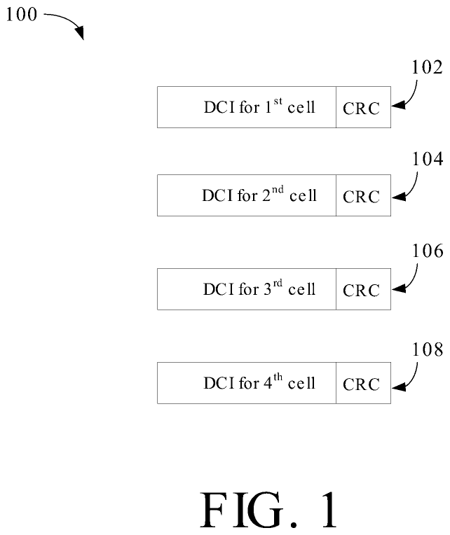

FIG. 1 illustrates an example scenario 100 of a DCI reception corresponding to a plurality of cells in accordance with the present disclosure. As shown in scenario 100, at least one BS may serve the UE for providing four DCIs 102, 104, 106 and 108. Specifically, the DCI 102 is utilized for a scheduling of a 1st cell with the UE, the DCI 104 is utilized for a scheduling of a 2nd cell with the UE, the DCI 106 is utilized for a scheduling of a 3rd cell with the UE, and the DCI 108 is utilized for a scheduling of a 4th cell with the UE. In one example, each DCI is attached with a cyclic redundancy check (CRC) for error decoding, and includes at least one designated bit field (e.g., 60 bits) and one CRC field (e.g., 24 bits), where the designated bit field includes a scheduling information for one cell. As that, the UE may communicate with the four cells (e.g., 1st cell, 2nd cell, 3rd cell and 4th cell) and perform a PDSCH reception or a PUSCH transmission scheduled by the four DCIs 102, 104, 106 and 108, respectively.

Based on different transmissions and capabilities of the UE, the network and the BS may configure a plurality of DCIs corresponding to a plurality of cells to the UE so as to schedule relevant resources for the DL/UL transmissions between the UE and the cells. However, it seems less efficient if the network resource(s) may not be enough to serve all UEs within the radio coverages. In addition, there is a bit-limit (e.g., less than 140 bits) for decoding the DCI if one specific decoding technique (e.g., polar decoding technique) is utilized by the UE. As that, it is proposed with a DCI aggregation for a scheduling of multi-cell PUSCH/PDSCH transmission.

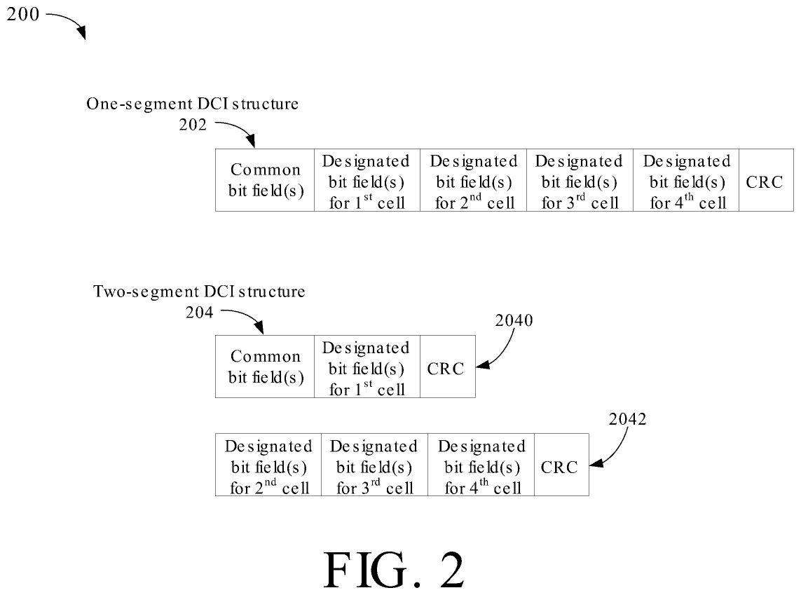

FIG. 2 illustrates an example scenario 200 illustrating two types of DCI structure in accordance with implementations of the present disclosure. As shown in scenario 200, the implementation in scenario 200 being similar to scenario 100 may include at least one BS serving the UE with four cells (e.g., 1^{st} cell, 2^{nd} cell, 3^{rd} cell and 4^{th} cell), and the difference is that the BS in the scenario 200 may configure a single DCI to the UE with the four cells (e.g., 1^{st} cell, 2^{nd} cell, 3^{rd} cell and 4^{th} cell). In one example, the UE may receive the single DCI via one cell (e.g., 1^{st} cell), and the other cells (e.g., 2^{nd} cell, 3^{rd} cell and 4^{th} cell) are scheduled by the same single DCI received in the previous cell (e.g., 1^{st} cell). Since the UE may utilize one specific decoding technique (e.g., polar decoding technique) for decoding the single DCI, the network and/or the BS may adaptively configure a field number/size of the single DCI complying with the bit-limit rule (e.g., less than 140 bits).

In some implementations, based on the bit-limit rule, the single DCI may have two types of DCI structure, i.e., a one-segment DCI structure 202 and a two-segment DCI structure 204. In one example, the one-segment DCI structure 202 may be an aggregated DCI including a common bit field, four designated bit fields corresponding to four cells (e.g., 1^{st} cell, 2^{nd} cell, 3^{rd} cell and 4^{th} cell), and a CRC bit field. In addition, the two-segment DCI structure 204 may include two DCI segments 2040 and 2042 that can be formed by adaptively dividing the one-segment DCI structure 202 as two independent DCIs, and the UE may link both the two DCI segments 2040 and 2042 together before deciding the DCI for scheduling information. Specifically, the DCI segment 2040 may include a common bit field, a first part of designated bit fields corresponding to at least one of the four cells and the CRC bit field, and the DCI segment 2042 may include a second part of designated bit fields corresponding the other cells and the CRC bit field. In one example, the DCI segment 2040 may have one designated bit field corresponding to one cell (e.g., 1^{st} cell), and the DCI segment 2042 may have three designated bit fields corresponding to three cells (e.g., 2^{nd} cell, 3^{rd} cell and 4^{th} cell).

In some implementations, the UE may receive a radio resource control (RRC) from the BS to configure which DCI field(s) to be the common bit field(s) and which DCI field(s) to be the designated bit field(s), i.e., the UE may adaptively determine field numbers for the common bit field and the plurality of designated bit fields in the one-segment DCI structure 202 or in the two-segment DCI structure 204. Specifically, for multi-cell PUSCH/PDSCH scheduling, the network may utilize a RRC configuration via the BS to assign which field(s) inside the DCI (e.g., the one-segment DCI structure 202 or the two-segment DCI structure 204) to be the common bit field(s) or to be the designated bit field(s). In addition, the network may independently assign the fields of the DCI (e.g., the one-segment DCI structure 202 or the two-segment DCI structure 204) for each of the scheduled cells (e.g., 1^{st} cell, 2^{nd} cell, 3^{rd} cell and 4^{th} cell).

In some implementations, the UE may receive a bitmap, a medium access control (MAC) control element (CE), another DCI (e.g., other than the received one-segment DCI structure 202 or the received two-segment DCI structure 204), or a pre-determined rule in any signaling/indication from the BS to configure which DCI field(s) to be the common bit field(s) and which DCI field(s) to be the designated bit field(s), i.e., the UE may adaptively determine the field numbers for the common bit field(s) and the plurality of designated bit fields of the DCI (e.g., the one-segment DCI structure 202 or the two-segment DCI structure 204). Thus, based on different transmissions and the number of scheduled cell(s), the network may adaptively configure which DCI field(s) to be the common bit field(s)/designated bit field(s) and/or the field numbers for the common bit field(s)/designated bit field(s) of the DCI (e.g., the one-segment DCI structure 202 or the two-segment DCI structure 204) by any of the above signaling/indication. In one example, the common bit field may be configured as 2, and the designated bit field may be configured as 4 for each cell, which is not limited hereinafter.

In some implementations, based on the scheduled cell(s) and transmission conditions, the DCI may include at least one of an information indicating a type of the one-segment DCI structure or the two-segment DCI structure, an information indicating which cell to be scheduled by the DCI (e.g., the one-segment DCI structure 202 or the two-segment DCI structure 204), a number of carrier(s) scheduled by the DCI (e.g., the one-segment DCI structure 202 or the two-segment DCI structure 204), and a matching information between the designated bit fields and the plurality of cells scheduled by the DCI (e.g., the one-segment DCI structure 202 or the two-segment DCI structure 204).

In one example, if the BS transmits the one-segment DCI structure 202 to the UE via one cell (e.g., 1st cell), the UE may be informed that this is a one-segment DCI structure. In addition, the UE may be informed of a number of cell(s) and/or a number of carrier(s) via an indication indicating a cell identification (ID) or a bitmap, and the UE may be informed of which cell(s) is/are scheduled by the designated bit field(s). In another example, if the BS transmits the two-segment DCI structure 204 to the UE via one cell (e.g., 1st cell), the UE may be informed that this is a two-segment DCI structure and which segment is received (e.g., the DCI segment 2040 or the DCI segment 2042). In addition, the UE may be informed of a number of cell(s) and/or a number of carrier(s) via an indication indicating a cell ID or a bitmap, and the UE may be informed of which cell(s) is/are scheduled by which DCI segment (e.g., the DCI segment 2040 or the DCI segment 2042) and its designated bit field. As that, the scheduling information of all cells (e.g., 1^{st} cell, 2^{nd} cell, 3^{rd} cell and 4^{th} cell) for performing any UL/DL transmission (e.g., a PUSCH or a PDSCH) with the UE may be configured by the single DCI (e.g., the one-segment DCI structure 202 or the two-segment DCI structure 204), which is more efficient with spared transmissions/resources and complies with the bit-limit rule.

In some implementations, the UE may receive a physical downlink control channel (PDCCH) scrambled by a first demodulation reference signal (DMRS) from the BS. As that, the UE may refer to the first DMRS to determine a number of cells scheduled by the single DCI (e.g., the one-segment DCI structure 202 or the two-segment DCI structure 204). In some implementations, the UE may receive a PDCCH scrambled by a second DMRS from the BS. As that, the UE may refer to the second DMRS to determine which cell is scheduled by the two-segment DCI (e.g., the DCI segment 2042 of the two-segment DCI structure 204).

In one example, a scrambling sequence of the first DMRS (or the second DMRS) may be utilized to indicate that there is no two-segment DCI structure (e.g., the two-segment DCI structure 204) or there is no two-segment DCI (e.g., the DCI segment 2042). In another example, a scrambling sequence of the first DMRS may be utilized to indicate a number of cells scheduled in the two-segment DCI (e.g., the DCI segment 2042). In another example, a scrambling sequence of the second DMRS may be utilized to indicate that which cells are scheduled by the two-segment DCI (e.g., the DCI segment 2042).

In some implementations, the UE may transmit a report to the BS and/or to the network. Specifically, the report may indicate a supportable number of cells that can be simultaneously scheduled by the single DCI (e.g., the one-segment DCI structure 202, the DCI segment 2040 of the two-segment DCI structure 204, and/or the DCI segment 2042 of the two-segment DCI structure 204). As that, based on a UE capability indicated by the report, the BS and/or the network may adaptively determine/configure an affordable number of cells to the UE before the UE performs the UL/DL transmission(s) with the cells.

In some implementations, the UE may receive a configuration from the BS or from the network, and the configuration may configure a maximum number of cells simultaneously scheduled by the single DCI (e.g., the one-segment DCI structure 202, the DCI segment 2040 of the two-segment DCI structure 204, and/or the DCI segment 2042 of the two-segment DCI structure 204). As that, based on the available resources of the network, the BS and/or the network may adaptively determine/configure the available cell(s) to the UE before the UE performs the UL/DL transmission(s). In one example, the maximum number of cells of the network may not be larger than the supportable number of cells of the UE.

In some implementations, the UE may determine a preparation time of the PUSCH based on the UE capability, and the BS and/or the network may be informed by the UE of the preparation time. Specifically, the preparation time may be initiated after a last symbol of the PDCCH is received by the UE. In addition, the preparation time may be determined based on a largest time value among different numerologies (e.g., based on sub-carrier space (SCS)) of the plurality of cells (e.g., 1^{st} cell, 2^{nd} cell, 3^{rd} cell and/or 4^{th} cell that may receive the single DCI or be scheduled by the same DCI). In one example, among the scheduled cells (e.g., 1^{st} cell, 2^{nd} cell, 3^{rd} cell and 4^{th} cell), if the SCS of some cells (e.g., 1^{st} cell and 3^{rd} cell) is 15 kilohertz (kHz) and the SCS of some cells (e.g., 2^{nd} cell and 4^{th} cell) is 30 kHz, the preparation time may be determined based on the largest time value (e.g., 1/14 millisecond (ms) corresponding to the SCS of 15 kHz).

In some implementations, the UE may determine a processing time of the PDSCH, and the BS and/or the network may be informed by the UE of the processing time. Specifically, the processing time may be initiated after a last symbol of the PDSCH is received by the UE. In addition, the processing time may be determined based on a largest time value among different numerologies (e.g., based on SCS) of the plurality of cells (e.g., 1^{st} cell, 2^{nd} cell, 3^{rd} cell and/or 4^{th} cell that may receive the single DCI, transmit a hybrid automatic repeat request-acknowledgement (HARQ-ACK), or be scheduled by the same DCI). In one example, among the scheduled cells (e.g., 1^{st} cell, 2^{nd} cell, 3^{rd} cell and 4^{th} cell), if the SCS of some cells (e.g., 1^{st} cell and 3^{rd} cell) is 15 kHz and the SCS of some cells (e.g., 2^{nd} cell and 4^{th} cell) is 30 kHz, the preparation time may be determined based on the largest time value (e.g., 1/14 ms corresponding to the SCS of 15 kHz).

### Illustrative Implementations

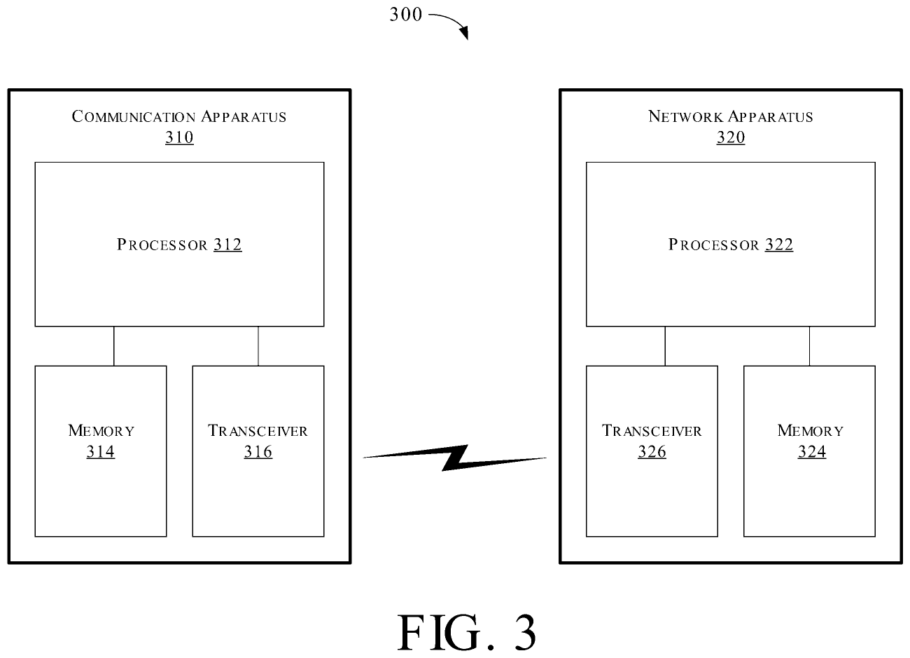

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to improvement of a scheduling of multi-cell PUSCH/PDSCH transmission with a single DCI, including scenarios/schemes described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT, NB-IoT or IIoT network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including autonomous reliability enhancements in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 312 may receive, via transceiver 316, a DCI indicating a scheduling of a plurality of cells from the network apparatus 320, wherein the DCI includes a first DCI, a second DCI, or a third DCI, the first DCI corresponds to a one-segment DCI structure, and the second DCI and the third DCI correspond to a two-segment DCI structure. Then, processor 312 may perform a PDSCH reception or a PUSCH transmission with at least one of the plurality of cells based on the DCI. The first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

In some implementations, processor 312 may receive, via transceiver 316, an RRC from the network apparatus 320 to configure which DCI field to be the common bit field and which DCI fields to be the plurality of designated bit fields.

In some implementations, processor 312 may receive, via transceiver 316, a bitmap, a MAC CE, a fourth DCI, or a pre-determined rule from the network apparatus 320 to configure which DCI field to be the common bit field and which DCI fields to be the plurality of designated bit fields.

In some implementations, the DCI includes at least one of an information indicating a type of the one-segment DCI structure or the two-segment DCI structure; an information indicating which cell to be scheduled by the first DCI, the second DCI, or the third DCI; a number of carrier scheduled by the first DCI, the second DCI, or the third DCI; and a matching information between the designated bit fields and the plurality of cells scheduled by the first DCI, the second DCI, or the third DCI.

In some implementations, processor 312 may receive, via transceiver 316, a first DMRS scrambled PDCCH from the network apparatus 320. Then, processor 312 may determine a number of cells scheduled by at least one of the first DCI, the second DCI, and the third DCI according to the first DMRS.

In some implementations, processor 312 may receive, via transceiver 316, a second DMRS scrambled PDCCH from the network apparatus 320. Then, processor 312 may determine which cell is scheduled by the third DCI according to the second DMRS.

In some implementations, processor 312 may transmit, via transceiver 316, a report to the network apparatus 320. The report indicates a supportable number of cells that can be simultaneously scheduled by at least one of the first DCI, the second DCI, and the third DCI.

In some implementations, processor 312 may receive, via transceiver 316, a configuration from the wireless network via the network apparatus 320. The configuration configures a maximum number of cells simultaneously scheduled by at least one of the first DCI, the second DCI, and the third DCI.

In some implementations, processor 312 may determine a preparation time of the PUSCH. The preparation time is initiated after a last symbol of the PDCCH is received by the communication apparatus 310, and is determined based on a largest time value among different numerologies of the plurality of cells.

In some implementations, processor 312 may determine a processing time of the PDSCH. The processing time is initiated after a last symbol of the PDSCH is received by the communication apparatus 310, and is determined based on a largest time value among different numerologies of the plurality of cells.

In some implementations, processor 322 may configure a DCI indicating a scheduling of a plurality of cells to the communication apparatus 310. The DCI includes a first DCI, a second DCI, or a third DCI, the first DCI corresponds to a one-segment DCI structure, and the second DCI and the third DCI correspond to a two-segment DCI structure in a SIB. Then, processor 322 may transmit, via transceiver 326, the DCI to the communication apparatus 310 to schedule a PDSCH reception or a PUSCH transmission with at least one of the plurality of cells based on the DCI. The first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

In some implementations, processor 322 may configure an RRC to the communication apparatus 310 to configure which DCI field to be the common bit field and which DCI fields to be the plurality of designated bit fields.

In some implementations, processor 322 may transmit, via transceiver 326, a bitmap, a MAC CE, a fourth DCI, or a pre-determined rule to the communication apparatus 310 to configure which DCI field to be the common bit field and which DCI fields to be the plurality of designated bit fields.

In some implementations, the DCI includes at least one of an information indicating a type of the one-segment DCI structure or the two-segment DCI structure; an information indicating which cell to be scheduled by the first DCI, the second DCI, or the third DCI; a number of carrier scheduled by the first DCI, the second DCI, or the third DCI; and a matching information between the designated bit fields and the plurality of cells scheduled by the first DCI, the second DCI, or the third DCI.

In some implementations, processor 322 may transmit, via transceiver 326, a first DMRS scrambled PDCCH to the communication apparatus 310. The first DMRS indicates a number of cells scheduled by at least one of the first DCI, the second DCI, and the third DCI.

In some implementations, processor 322 may transmit, via transceiver 326, a second DMRS scrambled PDCCH to the communication apparatus 310. The second DMRS indicates which cell is scheduled by the third DCI.

In some implementations, processor 322 may receive, via transceiver 326, a report from the communication apparatus 310. The report indicates a supportable number of cells that can be simultaneously scheduled by at least one of the first DCI, the second DCI, and the third DCI.

In some implementations, processor 322 may transmit, via transceiver 326, a configuration to the communication apparatus 310. The configuration configures a maximum number of cells simultaneously scheduled by at least one of the first DCI, the second DCI, and the third DCI.

In some implementations, processor 322 may determine a preparation time of the PUSCH of the communication apparatus 310. The preparation time is initiated after a last symbol of the PDCCH is received by the communication apparatus 310, and is determined based on a largest time value among different numerologies of the plurality of cells.

In some implementations, processor 322 may determine a processing time of the PDSCH of the communication apparatus 310. The processing time is initiated after a last symbol of the PDSCH is received by the communication apparatus 310, and is determined based on a largest time value among different numerologies of the plurality of cells.

### Illustrative Processes

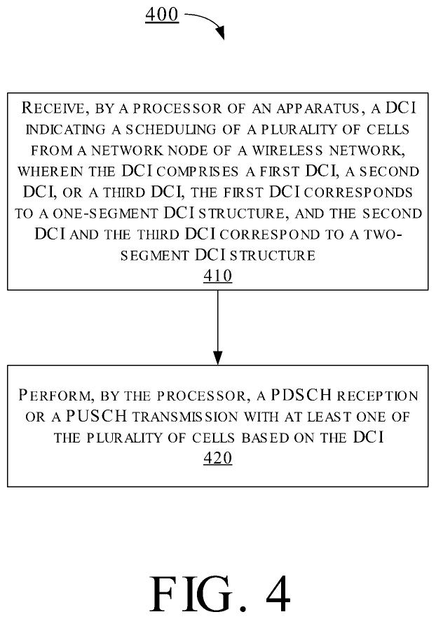

FIG. 4 illustrates an example process 400 in accordance with an implementation of the present disclosure. Process 400 may be an example implementation of above scenarios/schemes, whether partially or completely, with respect to improvement of a scheduling of multi-cell PUSCH/PDSCH transmission with a single DCI. Process 400 may represent an aspect of implementation of features of communication apparatus 310. Process 400 may include one or more operations, actions, or functions as illustrated by one or more of blocks 410 to 420. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a DCI indicating a scheduling of a plurality of cells from a network node (e.g., network apparatus 320) of a wireless network, wherein the DCI includes a first DCI, a second DCI, or a third DCI, the first DCI corresponds to a one-segment DCI structure, and the second DCI and the third DCI correspond to a two-segment DCI structure. Process 400 may proceed from 410 to 420.

At 420, process 400 may involve processor 312 performing a PDSCH reception or a PUSCH transmission with at least one of the plurality of cells based on the DCI, wherein the first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

In some implementations, process 400 may further involve processor 312 receiving an RRC from the network node (e.g., network apparatus 320) to configure which DCI field to be the common bit field and which DCI fields to be the plurality of designated bit fields.

In some implementations, process 400 may further involve processor 312 receiving a bitmap, a MAC CE, a fourth DCI, or a pre-determined rule from the network node (e.g., network apparatus 320) to configure which DCI field to be the common bit field and which DCI fields to be the plurality of designated bit fields.

In some implementations, the DCI includes at least one of an information indicating a type of the one-segment DCI structure or the two-segment DCI structure; an information indicating which cell to be scheduled by the first DCI, the second DCI, or the third DCI; a number of carrier scheduled by the first DCI, the second DCI, or the third DCI; and a matching information between the designated bit fields and the plurality of cells scheduled by the first DCI, the second DCI, or the third DCI.

In some implementations, process 400 may further involve processor 312 receiving a first DMRS scrambled PDCCH from the network node (e.g., network apparatus 320). Then, process 400 may further involve processor 312 determining a number of cells scheduled by at least one of the first DCI, the second DCI, and the third DCI according to the first DMRS.

In some implementations, process 400 may further involve processor 312 receiving a second DMRS scrambled PDCCH from the network node (e.g., network apparatus 320). Then, process 400 may further involve processor 312 determining which cell is scheduled by the third DCI according to the second DMRS.

In some implementations, process 400 may further involve processor 312 transmitting a report to the network node (e.g., network apparatus 320), wherein the report indicates a supportable number of cells that can be simultaneously scheduled by at least one of the first DCI, the second DCI, and the third DCI.

In some implementations, process 400 may further involve processor 312 receiving a configuration from the wireless network via the network node (e.g., network apparatus 320), wherein the configuration configures a maximum number of cells simultaneously scheduled by at least one of the first DCI, the second DCI, and the third DCI.

In some implementations, process 400 may further involve processor 312 determining a preparation time of the PUSCH, wherein the preparation time is initiated after a last symbol of the PDCCH is received by the communication apparatus 310, and is determined based on a largest time value among different numerologies of the plurality of cells.

In some implementations, process 400 may further involve processor 312 determining a processing time of the PDSCH, wherein the processing time is initiated after a last symbol of the PDSCH is received by the communication apparatus 310, and is determined based on a largest time value among different numerologies of the plurality of cells.

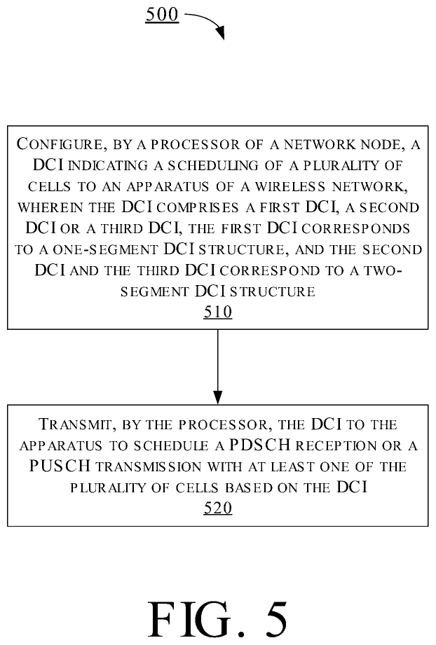

FIG. 5 illustrates an example process 500 in accordance with an implementation of the present disclosure. Process 500 may be an example implementation of above scenarios/schemes, whether partially or completely, with respect to improvement of a scheduling of multi-cell PUSCH/PDSCH transmission with a single DCI. Process 500 may represent an aspect of implementation of features of network apparatus 320. Process 500 may include one or more operations, actions, or functions as illustrated by one or more of blocks 510 to 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any suitable BS or network nodes. Solely for illustrative purposes and without limitation, process 500 is described below in the context of network apparatus 320. Process 500 may begin at block 510.

At 510, process 500 may involve processor 322 of network apparatus 320 configuring a DCI indicating a scheduling of a plurality of cells to an apparatus (e.g., communication apparatus 310) of a wireless network, wherein the DCI includes a first DCI, a second DCI, or a third DCI, the first DCI corresponds to a one-segment DCI structure, and the second DCI and the third DCI correspond to a two-segment DCI structure. Process 500 may proceed from 510 to 520.

At 520, process 500 may involve processor 322 transmitting the DCI to the apparatus (e.g., communication apparatus 310) to schedule a PDSCH reception or a PUSCH transmission with at least one of the plurality of cells based on the DCI, wherein the first DCI includes a common bit field and a plurality of designated bit fields corresponding to the plurality of cells, the second DCI includes the common bit field and a first part of the designated bit fields corresponding to at least one of the plurality of cells, and the third DCI includes a second part of the designated bit fields corresponding to at least one of the plurality of cells.

In some implementations, process 500 may further involve processor 322 configuring an RRC to the apparatus (e.g., communication apparatus 310) to configure which DCI field to be the common bit field and which DCI fields to be the plurality of designated bit fields.

In some implementations, process 500 may further involve processor 322 transmitting a bitmap, a MAC CE, a fourth DCI, or a pre-determined rule to the apparatus (e.g., communication apparatus 310) to configure which DCI field to be the common bit field and which DCI fields to be the plurality of designated bit fields.

In some implementations, the DCI includes at least one of an information indicating a type of the one-segment DCI structure or the two-segment DCI structure; an information indicating which cell to be scheduled by the first DCI, the second DCI, or the third DCI; a number of carrier scheduled by the first DCI, the second DCI, or the third DCI; and a matching information between the designated bit fields and the plurality of cells scheduled by the first DCI, the second DCI, or the third DCI.

In some implementations, process 500 may further involve processor 322 transmitting a first DMRS scrambled PDCCH to the apparatus (e.g., communication apparatus 310), wherein the first DMRS indicates a number of cells scheduled by at least one of the first DCI, the second DCI, and the third DCI.

In some implementations, process 500 may further involve processor 322 transmitting a second DMRS scrambled PDCCH to the apparatus (e.g., communication apparatus 310), wherein the second DMRS indicates which cell is scheduled by the third DCI.

In some implementations, process 500 may further involve processor 322 receiving a report from the apparatus (e.g., communication apparatus 310), wherein the report indicates a supportable number of cells that can be simultaneously scheduled by at least one of the first DCI, the second DCI, and the third DCI.

In some implementations, process 500 may further involve processor 322 transmitting a configuration to the apparatus (e.g., communication apparatus 310), wherein the configuration configures a maximum number of cells simultaneously scheduled by at least one of the first DCI, the second DCI, and the third DCI.

In some implementations, process 500 may further involve processor 322 determining a preparation time of the PUSCH of the apparatus (e.g., communication apparatus 310), wherein the preparation time is initiated after a last symbol of the PDCCH is received by the apparatus (e.g., communication apparatus 310), and is determined based on a largest time value among different numerologies of the plurality of cells.

In some implementations, process 500 may further involve processor 322 determining a processing time of the PDSCH of the apparatus (e.g., communication apparatus 310), wherein the processing time is initiated after a last symbol of the PDSCH is received by the apparatus (e.g., communication apparatus 310), and is determined based on a largest time value among different numerologies of the plurality of cells.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a downlink control information (DCI) indicating a scheduling of a plurality of cells from a network node of a wireless network, wherein the DCI comprises a first DCI, a second DCI, or a third DCI, the first DCI corresponds to a one-segment DCI structure, and the second DCI and the third DCI correspond to a two-segment DCI structure; and
performing, by the processor, a physical downlink shared channel (PDSCH) reception or a physical uplink shared channel (PUSCH) transmission with at least one of the plurality of cells based on the DCI,
wherein the first DCI comprises a common bit field and a plurality of designated bit fields corresponding to the plurality of cells, the second DCI comprises the common bit field and a first part of the designated bit fields corresponding to at least one of the plurality of cells, and the third DCI comprises a second part of the designated bit fields corresponding to at least one of the plurality of cells.

2. The method of claim 1, further comprising:
receiving, by the processor, a radio resource control (RRC) from the network node to configure which DCI field to be the common bit field and which DCI fields to be the plurality of designated bit fields.

3. The method of claim 2, further comprising:
receiving, by the processor, a bitmap, a medium access control (MAC) control element (CE), a fourth DCI, or a pre-determined rule from the network node to configure which DCI field to be the common bit field and which DCI fields to be the plurality of designated bit fields.

4. The method of claim 1, wherein the DCI comprises at least one of:
an information indicating a type of the one-segment DCI structure or the two-segment DCI structure;
an information indicating which cell to be scheduled by the first DCI, the second DCI, or the third DCI;
a number of carrier scheduled by the first DCI, the second DCI, or the third DCI; and
a matching information between the designated bit fields and the plurality of cells scheduled by the first DCI, the second DCI, or the third DCI.

5. The method of claim 1, further comprising:
receiving, by the processor, a first demodulation reference signal (DMRS) scrambled physical downlink control channel (PDCCH) from the network node; and
determining, by the processor, a number of cells scheduled by at least one of the first DCI, the second DCI, and the third DCI according to the first DMRS.

6. The method of claim 1, further comprising:
receiving, by the processor, a second DMRS scrambled physical downlink control channel (PDCCH) from the network node; and
determining, by the processor, which cell is scheduled by the third DCI according to the second DMRS.

7. The method of claim 1, further comprising:
transmitting, by the processor, a report to the network node,
wherein the report indicates a supportable number of cells that can be simultaneously scheduled by at least one of the first DCI, the second DCI, and the third DCI.

8. The method of claim 1, further comprising:
receiving, by the processor, a configuration from the wireless network via the network node,
wherein the configuration configures a maximum number of cells simultaneously scheduled by at least one of the first DCI, the second DCI, and the third DCI.

9. The method of claim 1, further comprising:
determining, by the processor, a preparation time of the PUSCH,
wherein the preparation time is initiated after a last symbol of the PDCCH is received by the apparatus, and is determined based on a largest time value among different numerologies of the plurality of cells.

10. The method of claim 1, further comprising:
determining, by the processor, a processing time of the PDSCH,
wherein the processing time is initiated after a last symbol of the PDSCH is received by the apparatus, and is determined based on a largest time value among different numerologies of the plurality of cells.

11. A method, comprising:
configuring, by a processor of a network node, a downlink control information (DCI) indicating a scheduling of a plurality of cells to an apparatus of a wireless network, wherein the DCI comprises a first DCI, a second DCI, or a third DCI, the first DCI corresponds to a one-segment DCI structure, and the second DCI and the third DCI correspond to a two-segment DCI structure; and
transmitting, by the processor, the DCI to the apparatus to schedule a physical downlink shared channel (PDSCH) reception or a physical uplink shared channel (PUSCH) transmission with at least one of the plurality of cells based on the DCI,
wherein the first DCI comprises a common bit field and a plurality of designated bit fields corresponding to the plurality of cells, the second DCI comprises the common bit field and a first part of the designated bit fields corresponding to at least one of the plurality of cells, and the third DCI comprises a second part of the designated bit fields corresponding to at least one of the plurality of cells.

12. The method of claim 11, further comprising:
configuring, by the processor, a radio resource control (RRC) to the apparatus to configure which DCI field to be the common bit field and which DCI fields to be the plurality of designated bit fields.

13. The method of claim 12, further comprising:
transmitting, by the processor, a bitmap, a medium access control (MAC) control element (CE), a fourth DCI, or a pre-determined rule to configure which DCI field to be the common bit field and which DCI fields to be the plurality of designated bit fields.

14. The method of claim 11, wherein the DCI comprises at least one of:
an information indicating a type of the one-segment DCI structure or the two-segment DCI structure;
an information indicating which cell to be scheduled by the first DCI, the second DCI, or the third DCI;
a number of carrier scheduled by the first DCI, the second DCI, or the third DCI; and
a matching information between the designated bit fields and the plurality of cells scheduled by the first DCI, the second DCI, or the third DCI.

15. The method of claim 11, further comprising:
transmitting, by the processor, a first demodulation reference signal (DMRS) scrambled physical downlink control channel (PDCCH) to the apparatus,
wherein the first DMRS indicates a number of cells scheduled by at least one of the first DCI, the second DCI, and the third DCI.

16. The method of claim 11, further comprising:
transmitting, by the processor, a second DMRS scrambled physical downlink control channel (PDCCH) to the apparatus,
wherein the second DMRS indicates which cell is scheduled by the third DCI.

17. The method of claim 11, further comprising:
receiving, by the processor, a report from the apparatus,
wherein the report indicates a supportable number of cells that can be simultaneously scheduled by at least one of the first DCI, the second DCI, and the third DCI.

18. The method of claim 11, further comprising:
transmitting, by the processor, a configuration to the apparatus,
wherein the configuration configures a maximum number of cells simultaneously scheduled by at least one of the first DCI, the second DCI, and the third DCI.

19. The method of claim 11, further comprising:
determining, by the processor, a preparation time of the PUSCH of the apparatus,
wherein the preparation time is initiated after a last symbol of the PDCCH is received by the apparatus, and is determined based on a largest time value among different numerologies of the plurality of cells.

20. The method of claim 11, further comprising:
determining, by the processor, a processing time of the PDSCH of the apparatus,
wherein the processing time is initiated after a last symbol of the PDSCH is received by the apparatus, and is determined based on a largest time value among different numerologies of the plurality of cells.
